(19) United States
(12) Patent Application Publication
(10) Pub. No.: US 2015/0074902 A1
(43) Pub. Date: Mar. 19, 2015

(54) SINK CLIP

(71) Applicant: Lyons Industries, Inc., Dowagiac, MI (US)

(72) Inventors: Lance Dale Lyons, Dowagiac, MI (US); Dale Allan Kehoe, Elkhart, IN (US); Richard Alexander Xouris, Granger, IN (US); Jerry Ted Pruszynski, Granger, IN (US); Bruce Miller, Bristol, IN (US); Allen Francis Elliott, Berrien Springs, MI (US); Paul William Emerson, Dowagiac, MI (US); Lisa Jo Laubach, Edwardsburg, MI (US); Fabiola Pliego Perez-Dussia, Holland, MI (US)

(73) Assignee: Lyons Industries, Inc., Dowagiac, MI (US)

(21) Appl. No.: 14/485,928

(22) Filed: Sep. 15, 2014

Related U.S. Application Data
(60) Provisional application No. 61/879,323, filed on Sep. 18, 2013.

(51) Int. Cl. E03C 1/33; B32B 37/12

(52) U.S. Cl. CPC E03C 1/33; B32B 37/12
USPC 4/695; 156/91

(57) ABSTRACT

A clip and method provided for temporarily positioning a sink during installation that includes the steps of providing a sink having a top ledge; providing a countertop having a hole therethrough for receiving the sink; providing a plurality of clips; attaching the clips to outer sides of the sink; placing a bottom end of the sink through the hole in the countertop until the top ledge of the sink is against the countertop and the clips engage sides of the hole in the countertop to position the sink therein; applying a caulk or adhesive material; and allowing the caulking or adhesive material to cure to permanently hold the sink in place. The clip may have a base portion extending in a planar orientation for at least a portion thereof; a resilient leg attached to and extending at an angle from one side of the base; and protrusions extending outwardly from one side of the resilient leg.

This application claims the benefit of U.S. Provisional Patent Application Ser. No. 61/879,323 filed Sep. 18, 2013, the complete disclosure of which is hereby expressly incorporated by reference.

### BACKGROUND OF THE INVENTION

This invention relates to a clip or bracket for installing a sink, and in particular to a clip or bracket that holds the sink in position as the caulking or adhesive cures, which will then permanently hold the sink.

For sinks that are installed in an opening of a countertop, one aspect of the installation is to assure that the sink is properly positioned and centered in the opening. This can be a time-consuming task requiring multiple measurements and repositioning of the sink. In addition, another problem is that during the process of caulking or adhering, the sink to the countertop, it may be bumped or moved so that it is no longer centered in the proper position.

One prior art remedy is to provide a positioning clip on the sink. Prior art positioning clips consisted of an angled metal bracket of which one angled leg is bonded or adhered to the sink. The other angled leg contains a cutout for receiving a metal tab therethrough. The other end of the metal tab contains a threaded hole for receiving a screw. When the sink is positioned in the opening of the countertop, the installer crawls beneath the sink and tightens screws extending through each tab against an underside of the countertop to temporarily secure the sink in position until the caulking or adhesive can cure.

Use of the prior art clips or brackets and tabs/holding screws is cumbersome, time-consuming, and requires an installer to work in an uncomfortable and limited space when tightening the holding screws.

Accordingly, it is an object of the present invention to provide an improved clip and method for temporarily positioning and holding a sink during the installation process until the caulking or adhesive can cure.

### SUMMARY OF THE INVENTION

In one embodiment of the invention, a clip is provided for use in positioning a sink during installation to temporarily hold the sink in position until the caulking or adhesive cures. The clip may have a base portion extending in a planar orientation for at least a portion thereof; a resilient leg attached to and extending at an angle from one side of the base; and protrusions extending outwardly from one side of the resilient leg.

The protrusions may have a teeth-like configuration, and the protrusions may also be made of a resilient material. The clip may have a molded unitary configuration and may be molded from an ABS plastic material.

The base may include a plurality of notches, where at least some of the notches can extend through the thickness of the base. The base may also include bevels through the thickness thereof at the edges of the notches. The notches may be widest on the side of the base from which the leg extends. At least one notch can extend inwardly from each side edge of the clip.

The leg may form an acute angle with the base, and the protrusions may extend into the acute angle. Alternately, the leg may form an obtuse angle with the base and the protrusions may extend into the obtuse angle. The leg may also have an arched configuration. The base may include an outer curved end where it may extend toward the leg to a side opposite the side of the leg having protrusions extending therefrom.

In another embodiment of the subject invention, a method is provided for temporarily positioning a sink during installation that includes the steps of providing a sink having a top ledge; providing a countertop having a hole therethrough for receiving the sink; providing a plurality of clips; attaching the clips to outer sides of the sink; placing a bottom end of the sink through the hole in the countertop until the top ledge of the sink is against the countertop and the clips engage sides of the hole in the countertop to position the sink therein; applying a caulk or adhesive material; and allowing the caulking or adhesive material to cure to permanently hold the sink in place.

The sink may be fiberglass and the method may include the step of pressing the clips into the fiberglass when wet to bond the clips to the sink. The clips may have a base that is bonded to the sink along a back side thereof, and a resilient leg may extend from a top side of the base of the clip.

The legs of the clip may include protrusions, which may extend in a teeth-like configuration. The protrusions may engage the sides of the hole in the countertop.

### BRIEF DESCRIPTION OF THE DRAWINGS

The above-mentioned and other features and objects of this invention and the manner of obtaining them will become more apparent and the invention itself will be better understood by reference to the following description of embodiments of the present invention taken in conjunction with the accompanying drawings, wherein:

FIG. 1 is a perspective view of a pair of sinks in an upside down position having clips in accordance with the subject invention attached thereto, ready for installation;

FIG. 2 is a perspective view of one embodiment of a first clip attached to an underside of the flange of the sink in FIG. 1;

FIG. 3 is a side view of the clip of FIG. 2;

FIG. 4 is a top plan view of the clip of FIG. 2;

FIG. 5 is a rear end view of the clip of FIG. 2;

FIG. 6 is a front end view of the clip of FIG. 2;

FIG. 7 is a perspective view of the sink of FIG. 1 showing clips being mounted thereto;

FIG. 8 is a side view of the sink of FIG. 1 being installed in an opening in a countertop using the clips;

FIG. 9 is a side view with the sink of FIG. 1 temporarily positioned in the countertop of FIG. 8 using the sink clips;

FIG. 10 is a top plan view of the sink of FIG. 1 with a caulking being applied between the sink and countertop for permanent placement of the sink;

FIG. 11 is a perspective view of one embodiment of a second clip shown attached to outer sides of the sink in FIG. 1;

FIG. 12 is a side view of the clip of FIG. 11;

FIG. 13 is a front end view of the clip of FIG. 11;

FIG. 14 is a bottom plan view of the clip of FIG. 11; and

FIG. 15 is a top plan view of the clip of FIG. 11.

Corresponding reference characters indicate corresponding parts throughout the several views. Although the drawings represent embodiments of the present invention, the drawings are not necessarily to scale and certain features may be exaggerated in order to better illustrate and explain the present invention. The exemplification set out herein illustrates embodiments of the invention, and such exemplifications are not to be construed as limiting the scope of the invention in any manner.

### DETAILED DESCRIPTION OF EMBODIMENTS OF THE INVENTION

For the purposes of promoting an understanding of the principles of the invention, reference will now be made to the embodiments illustrated in the drawings, which are described below. It will nevertheless be understood that no limitation of the scope of the invention is thereby intended. The invention includes any alterations and further modifications in the illustrated devices and described methods and further applications of the principles of the invention, which would normally occur to one skilled in the art to which the invention relates.

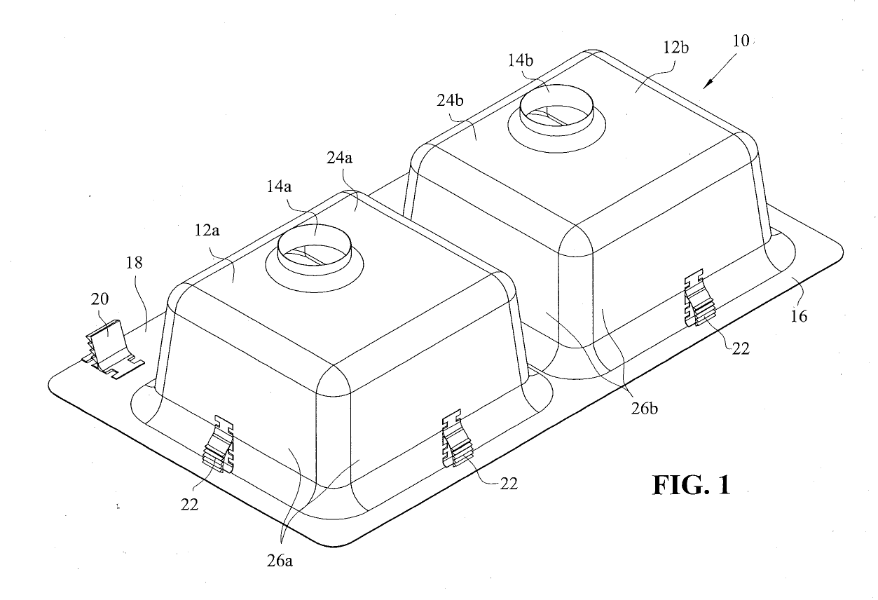

Now referring to FIG. 1, a sink assembly is shown, generally indicated as 10. Sink assembly 10 can be formed from any of the well-known materials or processing methods used therefor. In one embodiment, sink assembly 10 may be molded from fiberglass materials. Sink assembly 10 includes a pair of sink basins 12a, 12b, each having a respective drain opening 14a, 14b; an upper ledge 16 from which sink basins 12a and 12b extend; a flange 18 extending from upper ledge 16; and a plurality of first clips or brackets 20 and second clips or brackets 22 attached to sink assembly 10 as described in detail below for use in positioning sink assembly 10 during installation.

Basins 12a and 12b each include, respectively, bottoms 24a, 24b; and side walls 26a, 26b. Clips 20 are bonded, adhered or otherwise attached or bonded to a bottom side of flange 18, and clips 22 are bonded, adhered or otherwise attached to the outside of side walls 26a, 26b as shown in FIG. 1 and described in further detail below.

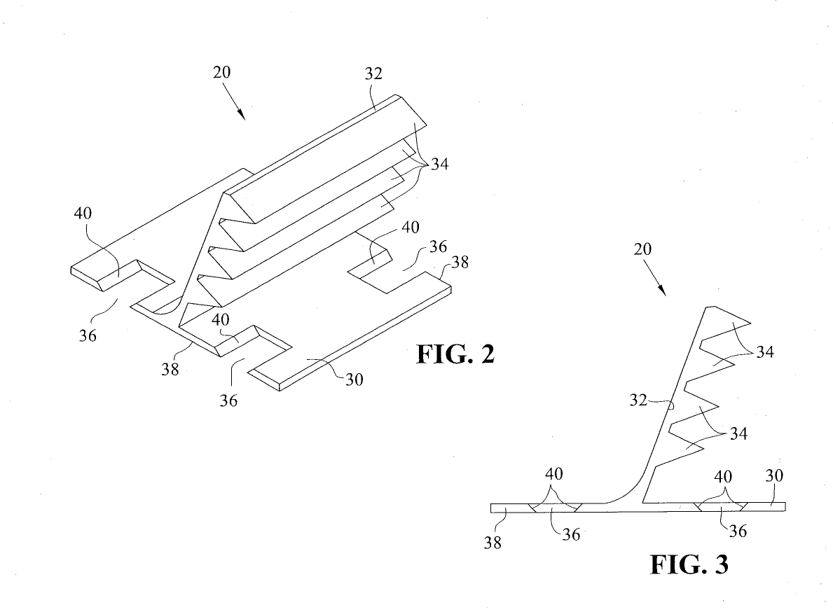

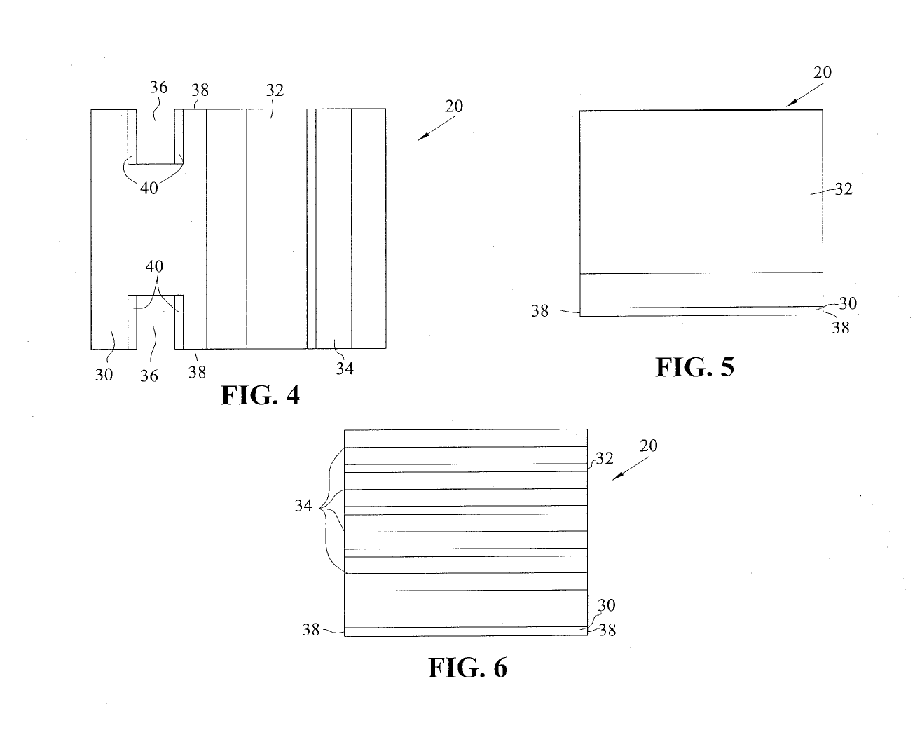

Now referring to FIGS. 2-6, details of clip 20 are provided. Clip 20 may be made from any suitable material having sufficient toughness and resiliency. One such acceptable or suitable material is Acrylonitrile Butadiene Styrene (ABS). Clip 20 may be manufactured from several pieces and bonded, adhered or otherwise attached together. However, clip 20 may also be molded as a unitary integral member. In the embodiment shown, clip 20 includes a base 30 and a leg 32 extending from one side of base 30 at an angle thereto. Clip 20 also includes a series of projections or protrusions 34 extending from leg 32 into the acute angle formed between leg 32 and base 30. In the configuration depicted, protrusions 34 have a linear teeth-like configuration, similar to that of a gear.

Base 30 also includes a plurality or series of notches 36 which extend through the thickness of the base. Notches 36 extend inwardly from side edges 38 of base 30, and in the embodiment shown, are aligned with the notches extending inwardly from the opposite side edge 38. Notches 36 also include beveled edges 40 so that the openings of notches 36 on the side of base 30 from which leg 32 extends is wider than on the opposite side of the base. The notches and bevels help in the bonding or attaching of base 30 to sink assembly 10 as described in further detail below.

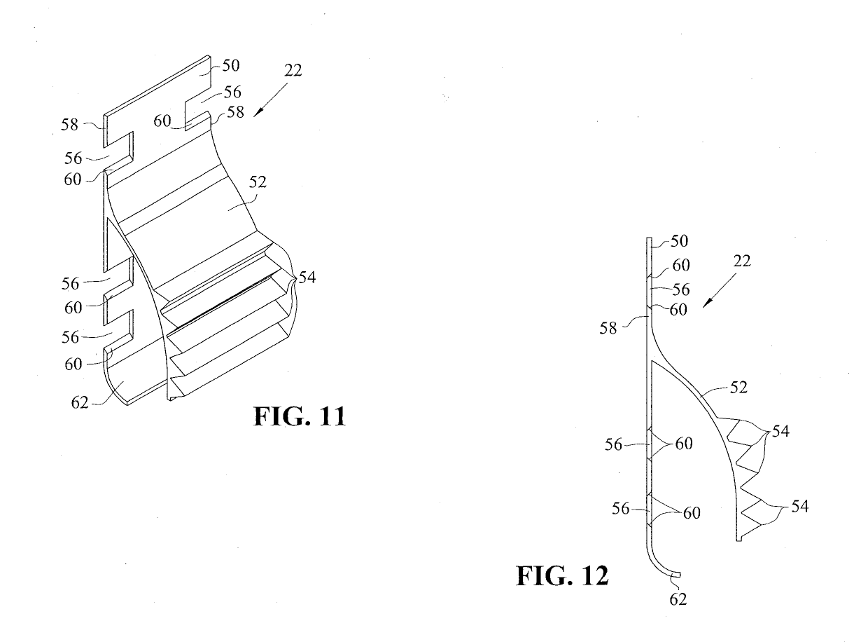

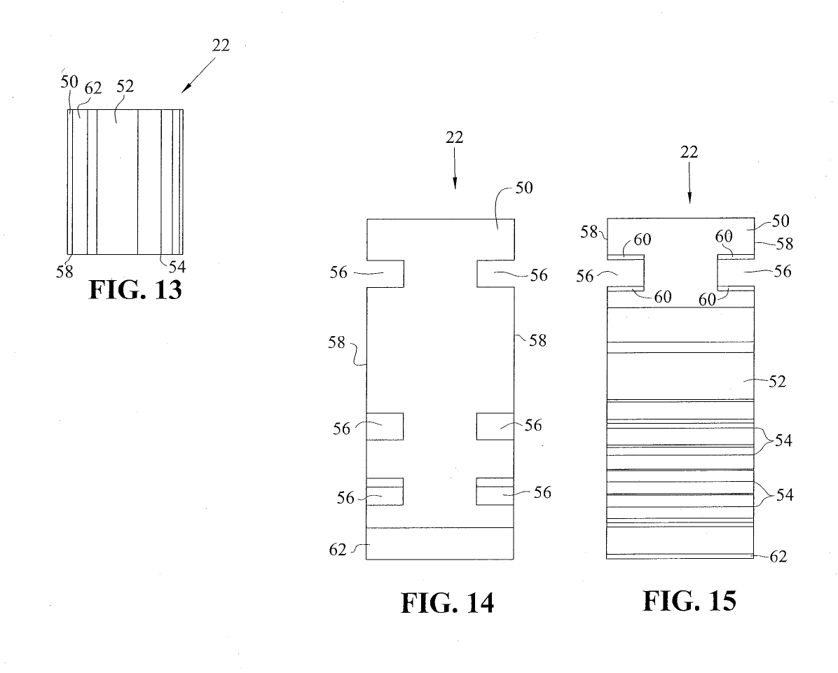

Now referring to FIGS. 11-15, details of clip 22 are depicted. Many aspects of clip 22 are similar to that of clip 20 and it may be manufactured in a similar manner and from similar materials. Also, as with clip 20, clip 22 includes a base 50, a leg 52 attached to and extending from one side of base 50, and projections or protrusions 54 extending from leg 52. Leg 52 extends from base 50 at an angle thereto; however, protrusions 54 extend into the obtuse angle created between leg 52 and base 50 rather than the acute angle as with clip 20. Furthermore, leg 32 of clip 20 extends in a generally planar orientation whereas leg 52 extends in an arched configuration in the embodiment shown. Similar to protrusions 34, protrusions 54 have a linear teeth-like configuration similar to that of gear. Base 50 also includes notches 56 extending through the thickness thereof. In the configuration shown, clip 22 includes a total of six notches 36 with three extending inwardly from each side edge 58 of base 50. Notches 56 also include beveled edges 60 so that the opening of notches 56 on the side of base 50 from which leg 52 extends is wider than on the opposite side of the base. As noted above regarding clip 20, the notches and bevels help in the bonding or attaching of base 50 to sink assembly 10 as described in further detail below. Base 50 also includes a curved end 62, which extends upwardly toward the opposite side of leg 52 from which projections 54 extend.

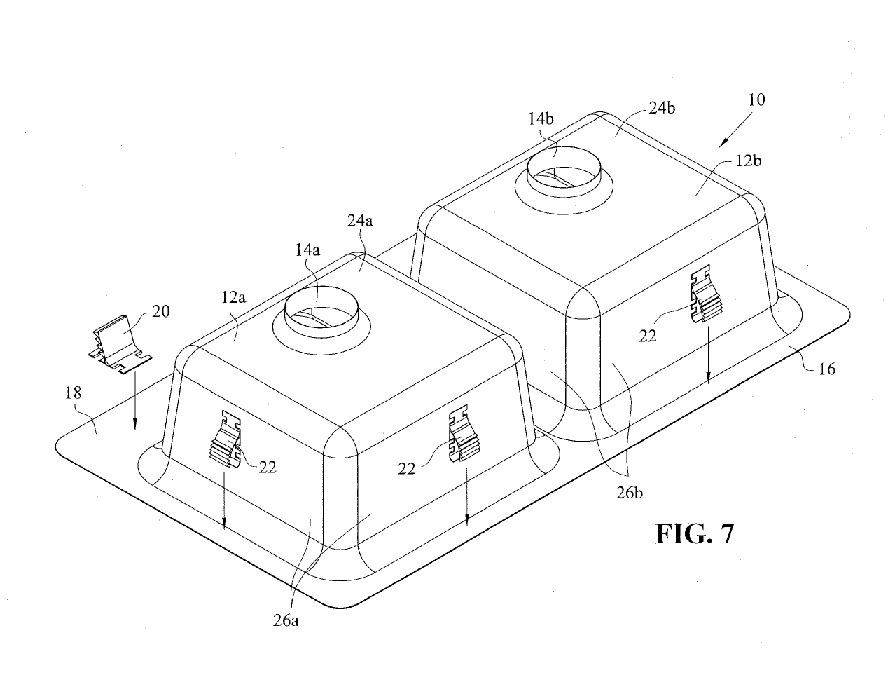

Now referring to FIGS. 7-10, mounting and use of clips 20 and 22 will be discussed. In one method of manufacture, sink shells are molded from a plastic material and then sprayed on the exterior thereof with fiberglass. While the fiberglass is still wet, bases 30 of clip 20 are pressed onto the underside of flange 18 and bases 50 of clips 22 are pressed to side walls 26a, 26b as shown in FIG. 7. If the clip is made from ABS plastic, this bonds to the fiberglass through a chemical reaction. Notches 36 and 56 in respective bases 30 and 50, as well as, respective beveled edges 40 and 60, enhance the bonding process and holding of the bases to the cured fiberglass. Once the curing process is complete, the edges of the sink can be cut and prepped so that the sink is ready for installation.

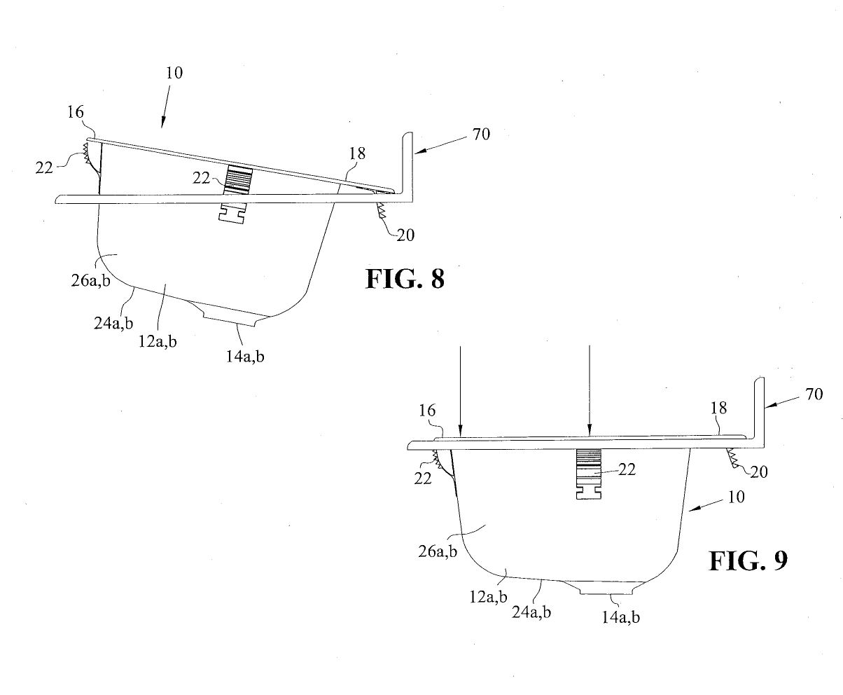

Now referring to FIGS. 8 and 9, the sink is initially placed in an opening (not shown) of the countertop 70 at an angle (see FIG. 8) so that clips 20 engage the back side of the opening in countertop 70. Then, the front side of sink assembly 10 is pushed down while holding the faucet side against the countertop. Pushing down firmly makes sure the sink fits flush on countertop 70 (see FIG. 9). Projections 34 and 54 snap into place along the side edges of the opening in countertop 70 so that the teeth of the projections grip the countertop holding the sink flush against countertop 70.

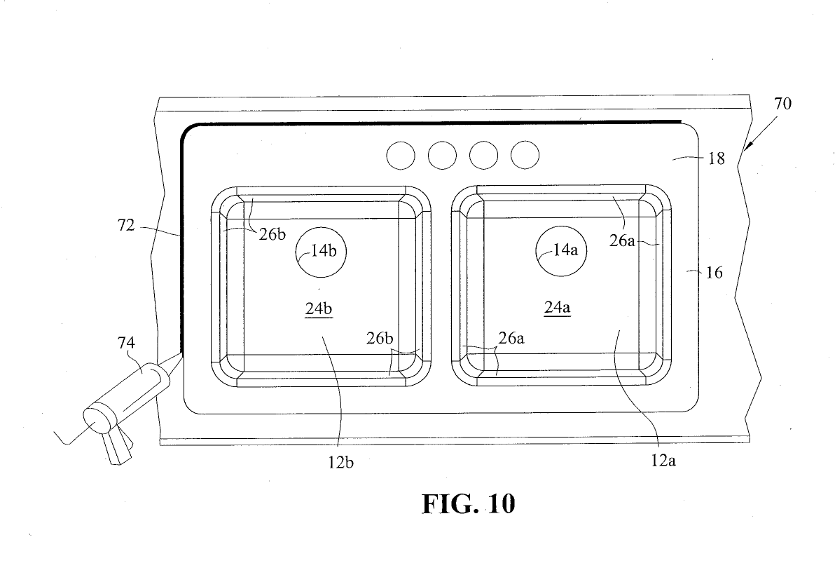

Next, caulking 72 can be applied using a caulking gun 74 or other known methods as shown in FIG. 10 around the edges of sink assembly 10 and in the crack between the sink and countertop 70. A high grade of color matched or clear silicon may be preferable to permanently hold the sink assembly 10 in place.

While the invention has been taught with specific reference to these embodiments, one skilled in the art will recognize that changes can be made in form and detail without departing from the spirit and scope of the invention. For example, the sink basin may have one, two, three or more basins in the shape of the basin and/or ledge/flange may be varied as desired. Furthermore, more or less clips may be used and the placement of the clips may be varied. It should also be appreciated that the shape of the projections may be varied or even eliminated and that the curvature, length, and angle of both the leg and base of the clip may be varied. In addition, the number, position, size, beveling, and thickness of the notches may be varied or eliminated or certain aspects may be changed or eliminated. The notches do not necessarily have to extend completely through the thickness of the base.

The described embodiments are to be considered, therefore, in all respects only as illustrative and not restrictive. As such, the scope of the invention is indicated by the following claims rather than by the description.

1. A clip for use in positioning a sink during installation, the clip comprising:
a base portion extending in a planar orientation for at least a portion thereof;
a resilient leg attached to and extending at an angle from one side of said base; and
protrusions extending outwardly from one side of said resilient leg.

2. The clip for use in positioning a sink during installation as set forth in claim 1, wherein said protrusions have a teeth-like configuration.

3. The clip for use in positioning a sink during installation as set forth in claim 2, wherein said protrusions are also made of a resilient material.

4. The clip for use in positioning a sink during installation as set forth in claim 3, wherein said clip has a molded unitary configuration.

5. The clip for use in positioning a sink during installation as set forth in claim 4, wherein said clip is molded from an ABS plastic material.

6. The clip for use in positioning a sink during installation as set forth in claim 1, wherein said base includes a plurality of notches.

7. The clip for use in positioning a sink during installation as set forth in claim 6, wherein at least some of said notches extend through the entire thickness of said base.

8. The clip for use in positioning a sink during installation as set forth in claim 7, wherein said base includes bevels through the thickness thereof along edges of said notches.

9. The clip for use in positioning a sink during installation as set forth in claim 8, wherein said notches are widest on said side of said base from which said leg extends.

10. The clip for use in positioning a sink during installation as set forth in claim 6, wherein at least one notch extends inwardly from each side edge of said clip.

11. The clip for use in positioning a sink during installation as set forth in claim 1, wherein said leg forms an acute angle with said base and said protrusions extend into said acute angle.

12. The clip for use in positioning a sink during installation as set forth in claim 1, wherein said leg forms an obtuse angle with said base and said protrusions extend into said obtuse angle.

13. The clip for use in positioning a sink during installation as set forth in claim 12, wherein said leg has an arched configuration.

14. The clip for use in positioning a sink during installation as set forth in claim 13, wherein said base includes an outer curved end.

15. The clip for use in positioning a sink during installation as set forth in claim 14, wherein said outer curved end of said base extends toward said leg to a side opposite the side of said leg having protrusions extending therefrom.

16. A method for temporarily positioning a sink during installation thereof, said method including the steps:
providing a sink having a top ledge;
providing a countertop having a hole therethrough for receiving said sink;
providing a plurality of clips;
attaching said clips to outer sides of said sink;
placing a bottom end of said sink through the hole in the countertop until the top ledge of said sink is against the countertop and said clips engage sides of the hole in the countertop to position said sink therein;
applying a caulk or adhesive material; and
allowing the caulking or adhesive material to cure to permanently hold said sink in place.

17. The method for temporarily positioning a sink during installation as set forth in claim 16, wherein said sink is fiberglass and further including the step of pressing the said clips into the fiberglass when wet to bond said clips to said sink.

18. The method for temporarily positioning a sink during installation as set forth in claim 17, wherein said clips have a base, said base being bonded to said sink along a back side thereof, and a resilient leg extends from a top side of said base of said clip.

19. The method for temporarily positioning a sink during installation as set forth in claim 18, wherein said legs of said clip include protrusions extending therefrom, the protrusions engaging the sides of the hole in the countertop.

20. The method for temporarily positioning a sink during installation as set forth in claim 19, wherein said protrusions extend in a teeth-like configuration.
